(19) United States
(12) Patent Application Publication
(10) Pub. No.: US 2011/0063436 A1
(43) Pub. Date: Mar. 17, 2011

(54) DISTANCE ESTIMATING APPARATUS

(75) Inventor: Masami MIZUTANI, Kawasaki (JP)

(73) Assignee: FUJITSU LIMITED, Kawasaki-shi (JP)

(21) Appl. No.: 12/883,869

(22) Filed: Sep. 16, 2010

(30) Foreign Application Priority Data
Sep. 17, 2009 (JP) 2009-215421

(51) Int. Cl. H04N 7/18

(52) U.S. Cl. 348/135; 348/E07.085

(57) ABSTRACT

A distance estimating apparatus includes a mirror, a camera device for obtaining an original image including a real image of the object and a mirror image of the object mirrored by the mirror, and a processor for calculating a distance between the camera device and the object on the basis of a correlation of a position of the real image included in the original image and a position of the mirror image included in the image.

### CROSS-REFERENCE TO RELATED APPLICATION

This application is based upon and claims the benefit of priority of the prior Japanese Patent Application No. 2009-215421, filed on Sep. 17, 2009 the entire contents of which are incorporated herein by reference.

### FIELD

The embodiment discussed herein is related to a distance estimating apparatus that estimates the distance to an object seen in an image.

### BACKGROUND

A distance estimating apparatus capable of estimating the distance to an object on the basis of image information about a captured image detects the object seen in an image obtained by a camera, and estimates the distance between the camera and the object. The apparatus for estimating the distance to the object on the basis of the image information is applied to, for example, a vehicle-mounted camera monitoring apparatus that provides visual assistance to a driver of a vehicle. When the vehicle-mounted camera monitoring apparatus is a back monitor, the driver can grasp the situation, such as the presence or absence of an obstacle around the vehicle that is not seen normally, while viewing an image output from the vehicle-mounted camera monitoring apparatus to a monitor.

For example, the distance to the object is estimated from a captured image by performing distance measurement using mirror-image areas corresponding to a plurality of mirrors. However, since this technique uses a plurality of mirrors, calibration of the positions and postures of the virtual camera viewpoints is complicated. In another technique, one image pickup area is divided in three by placing mirrors on the right and left sides in front of an image pickup element and placing a wide angle lens between the mirrors, and distance measurement is performed using mirror-image areas. This technique uses a plurality of mirrors in order to perform distance measurement using the mirror-image areas, and this increases the cost and complicates calibration. The above-described techniques are disclosed in, for example, Japanese Laid-Open Patent Publication Nos. 2002-347517, 2004-289305, and 10-9853.

### SUMMARY

According to an aspect of the invention, a distance estimating apparatus includes a mirror, a camera device for obtaining an original image including a real image of the object and a mirror image of the object mirrored by the mirror, and a processor for calculating a distance between the camera device and the object on the basis of a correlation of a position of the real image included in the original image and a position of the mirror image included in the image.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a distance estimating apparatus according to an embodiment;

FIG. 2 explains positions of a camera device and a mirror, and an image pickup area;

FIG. 3 illustrates an internal configuration of an ECU;

FIG. 4 explains a method for calculating a correspondence relationship between the camera device and the mirror;

FIG. 5 is a flowchart illustrating a process for calculating the distance;

FIG. 6 illustrates an example of an original image;

FIG. 7 illustrates a state after rotation correction;

FIG. 8 illustrates a fisheye image after rotation correction for making a normal vector parallel to a camera coordinate system;

FIG. 9 illustrates a cylindrical image obtained by cylindrical transformation of the fisheye image subjected to rotation correction;

FIG. 10 explains a vertical relationship of the cylindrical image;

FIG. 11 explains a method for calculating the distance; and

FIG. 12 illustrates an example of an image output to a monitor.

### DESCRIPTION OF EMBODIMENTS

Hereinafter, preferred embodiment will be described in detail with reference to drawings. A distance estimating apparatus according to an embodiment is applied to a back monitor mounted in a vehicle so as to monitor the surroundings (especially a rear side) of the vehicle.

Outline of the Embodiment

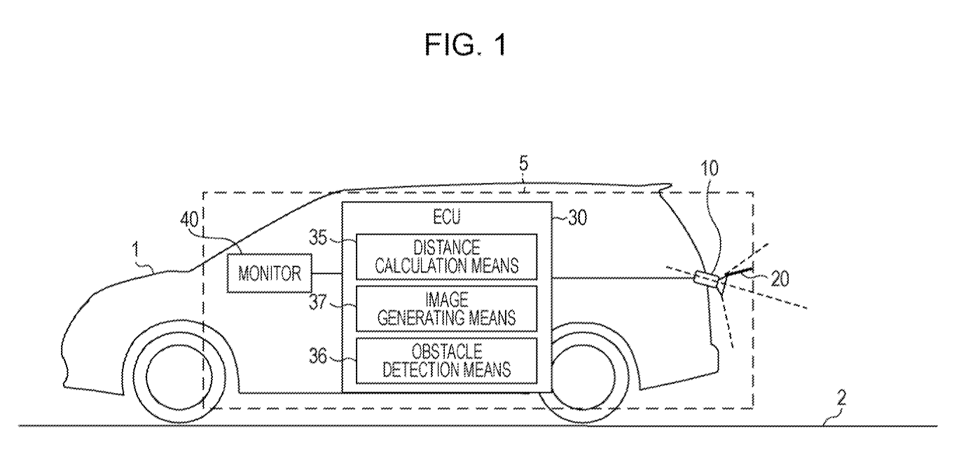

FIG. 1 illustrates a distance estimating apparatus 5 according to the embodiment. The distance estimating apparatus 5 is mounted in a vehicle 1, and detects an obstacle and so on existing around the vehicle 1, for example, on a road surface 2. The distance estimating apparatus 5 includes a camera device 10, a mirror 20, an electronic control unit (ECU) 30, and a monitor 40. In this embodiment, the camera device 10 is mounted near a rear end of the vehicle 1.

The camera device 10 is set at a position such as to be able to directly capture an image of an obstacle around the rear side of the vehicle 1. In the embodiment, the camera device 10 includes a fisheye lens unit. While the mirror 20 is mounted near the camera device 10 in the embodiment, it may be mounted in the camera device 10 or the vehicle 1. The camera device 10 and the mirror 20 are set so that a real image of an object is directly captured by the camera device 10 and a mirror image of the object is also captured by the camera device 10, and so that light for capturing a real image in an image pickup area of the camera device 10 and light for capturing a mirror image pass through the same fisheye lens unit and form images on the same image pickup element. The distance estimating apparatus estimates the distance to the object on the basis of an angular difference from the camera center between a real image and a mirror image that are formed on the same image pickup element via the same lens. Hence, the distance estimating apparatus can estimate the distance with a simpler configuration than before. The ECU 30 processes a captured image output from the camera device 10. The ECU 30 includes a distance calculation module 35 for calculating the distance to an object seen in an original image, an obstacle detection module 36 for detecting an obstacle, and an image generating module 37 for generating an image to be output to the monitor 40. The monitor 40 displays the image output from the ECU 30. The monitor 40 can output information about the obstacle detected by the ECU 30 and the distance to the obstacle, for example, as audio information, instead of image information.

Camera Device and Mirror

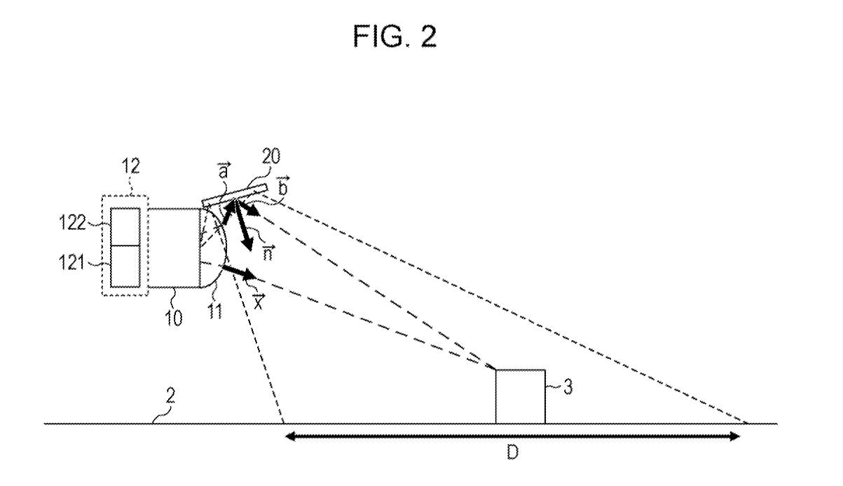

Next, a description will be given of an image pickup operation of the camera device 10. FIG. 2 explains the positions of the camera device 10 and the mirror 20, and an image pickup area. The camera device 10 is set, for example, near the rear end of the vehicle 1, and includes a fisheye lens unit 11 and an image pickup element 12. For example, the fisheye lens unit 11 is formed by a combination of a plurality of optical lenses, and has an angle of view of about 180 degrees. The image pickup element 12 converts light obtained via the fisheye lens unit 11 into image information. An image pickup area of the image pickup element 12 includes a real-image area 121 where an image of an object 3 on the road surface 2 is captured via the fisheye lens unit 11, and a mirror-image area 122 where a mirror image of the object 3 on the road surface 2 obtained by reflection from the mirror 20 is captured via the fisheye lens unit 11.

For example, to calculate the distance to an object existing just behind the vehicle, the camera device 10 is preferably set with a depression angle such that a lower end of the real-image area 121 can capture an image of the road surface 2 just below the rear end of the vehicle 1. This is because the fisheye lens unit 11 is circular in contrast to the image pickup element 12 that is rectangular. In the embodiment, to effectively use pixels of the image pickup element 12, the image pickup element 12 captures an image of an area in a part of the angle of view that the fisheye lens unit 11 can obtain. Therefore, even when the fisheye lens unit 11 has an angle of view of 180 degrees, the image pickup area of the image pickup element 12 is smaller than the area of 180 degrees. For example, to acquire an angle of view of 130 degrees in the vertical direction of the image pickup element 12, the camera device 10 is set at a downward depression angle of 25 degrees from the horizontal direction. Further, the camera device 10 is set so that the real-image area 121 can capture an image of an obstacle around the vehicle 1.

By applying the fisheye lens unit 11 to the camera device 10, an image of the surroundings of the vehicle 1 can be captured at a wide angle of view in the horizontal direction. For this reason, the surroundings of the vehicle 1 can be monitored with a small number of cameras. As the optical lens in the camera device 10, a normal lens or a wide-angle lens can also be used instead of the fisheye lens. Further, the fisheye lens unit 11 has a wide angle of view not only in the horizontal direction, but also in the vertical direction. While an image of the sky does originally not need to be acquired as an image used to check the rear side for the safety purpose, it is captured in the image pickup area. In the embodiment, a mirror image of the image in the real-image area 121 is projected by the mirror 20 into the unnecessary area of the sky. As a result, the distance to the object in the real-image area 121 and the mirror-image area 122 can be calculated by, for example, triangulation.

The mirror 20 of the embodiment is assumed as a plane mirror. For example, the mirror 20 is set near the camera device 10 and on the upper side of the camera device 10 in a manner such as to face the ground surface. While a sunshade for preventing entrance of sunlight is normally provided in an upper part of the camera device 10, the mirror 20 can have the shading effect in the embodiment. The mirror 20 is set so that a part of the real-image area 121, where the distance to the object is to be measured, is captured in the mirror-image area 122 as a mirror image reflected by the mirror 20. Further, the mirror 20 is set so that a substantially upper half of the image pickup element 12 of the camera device 10 serves as the mirror-image area 122. The camera device 10 and the mirror 20 are set so that a bottom end of the real-image area 121, that is, an image of the road surface 2 substantially beneath the lower end of the vehicle 1 is captured at an upper end of the mirror-image area 122. The mirror 20 is set at a predetermined angle to the optical axis of the camera device 10 and faces the road surface 2 at a predetermined angle.

The area of the mirror 20 differs according the vehicle because it is limited by the shape of the vehicle. An area where the distance to the object can be calculated (distance measuring area D) depends on the distance between the camera device 10 and the mirror 20, the size of the mirror 20, the angular difference between the normal direction of the mirror surface and the camera center axis, etc. Hence, to maximize the image pickup area of the image pickup element 12 capable of measuring the distance, it is preferable to arrange the camera device 10 and the mirror 20 so that the image pickup area of the image pickup element 12 is bisected into the real-image area 121 and the mirror-image area 122. The mirror 20 is set so that light for a real image of an object to be measured for the distance and light for a mirror image of the object form images on the image pickup element.

With the above-described arrangement, light for the real image and light for the mirror image received by the camera device 10 can pass through the same fisheye lens unit 11, and form images on different areas on the same image pickup element 12. Thus, the distance estimating apparatus 5 has a configuration such that the real image and the mirror image necessary for calculating the distance pass through the same optical lens and are received by the same image pickup element. This facilitates rotation correction of the image and calculation of the distance that will be described below.

With the above-described structures of the camera device 10 and the mirror 20, the real image of the road surface can be directly captured via the fisheye lens unit 11 in about the lower half of the image pickup area of the image pickup element 12 in the rear camera monitor system in the vehicle 1. As a result, the quality of the image in the real-image area 121 serving as about the lower half of the image pickup element 12 can be ensured, and resolution of the image pickup element 12 in the horizontal direction does not decrease. Further, about the upper half of the image pickup element 12, where the image of the sky is unnecessarily captured in normal cases, can be used as the mirror-image area 122 for distance measurement.

For example, the camera device 10 is set at the center of the vehicle 1 in the height direction, and near the backmost end of the vehicle 1 in the horizontal direction.

The image captured by the camera device 10 is sent to the ECU 30.

ECU

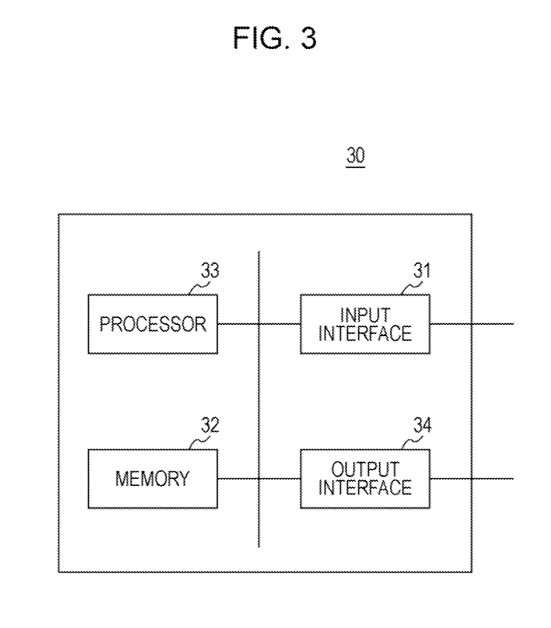

The ECU 30 will now be described. FIG. 3 illustrates an example of an internal configuration of the ECU 30. The ECU 30 includes an input interface 31 for receiving an image from the camera device 10, a processor 33 for controlling overall operation of the ECU 30, a memory 32 for storing an original image from the camera device 10, various parameters for image processing, a program for causing the processor 33 to perform image processing, etc., and an output interface 34 for outputting the image to the monitor 40 after image processing. The input interface 31, the processor 33, the memory 32, and the output interface 34 are connected each other.

The processor 33 performs an operation of determining the angular relationship between the camera device 10 and the mirror 20 by calibration, an operation of conducting rotation correction on the original image, an operation of measuring the distance to the object on the basis of a predetermined correspondence relationship between the real image and the mirror image, an operation of combining the measured distance information with the image, and an operation of outputting the image combined with the distance information to the monitor 40 via the output interface 34.

Precalculation of Angular Relationship Between Camera and Mirror

Next, a correspondence relationship between the camera device 10 and the mirror 20 used to measure the distance from the camera device 10 to the object is found. For example, this correspondence relationship is found beforehand by calibration of the apparatus. In the embodiment, an angle θ between a normal vector n of the mirror 20 and the Y-axis in the camera coordinate system is calculated as the correspondence relationship. The distance estimating apparatus 5 estimates the distance from the camera device 10 to the object on the basis of misalignment between the real image and the mirror image of the object captured by the camera device 10.

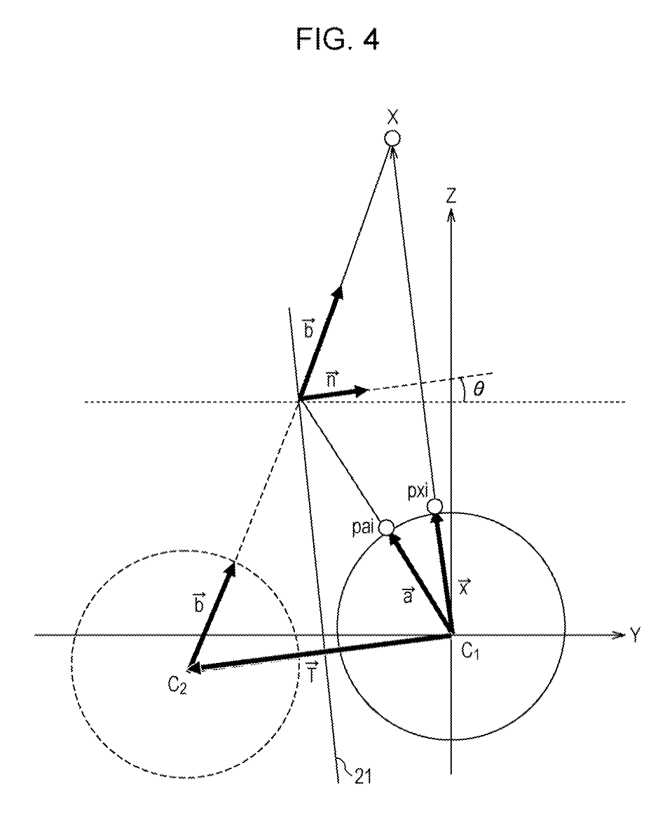

FIG. 4 explains a method for calculating the correspondence relationship between the camera device 10 and the mirror 20. While the correspondence relationship between the camera device 10 and the mirror 20 of the embodiment is three-dimensionally considered, it is two-dimensionally expressed for ease of explanation in FIG. 4. In FIG. 4, n represents a normal vector of the mirror 20, and the normal vector n is an arbitrary three-dimensional vector. Since the mirror 20 of the embodiment is a plane mirror, it has one normal vector n. Y and Z represent an Y-axis and a Z-axis, respectively, of the coordinate system of a camera C1. The Z-axis serves as the optical axis of the camera C1. A point X represents a point in the real world. The camera C1 and a virtual camera C2 are symmetrically arranged with respect to a mirror surface 21 of the mirror 20. T represents a base line used in measurement for calculating the distance from the camera C1 to the point X. The magnitude of the base line vector T is expressed by the magnitude of the normal vector n by an arbitrary number d. Further, x represents a vector of light to the point X (direct light vector), and pxi (i is an integer) represents a corresponding point in the image. Also, a represents an incident light vector provided when a mirror image of the point X is captured by the camera C1, and pai (i is an integer) represents a corresponding point in the image. Still further, b represents a reflected light vector provided when the incident light vector a is reflected by the mirror surface 21, and θ represents the angle formed between the normal vector n and a unit vector of the Y-axis.

Next, a description will be given of a procedure for calculating the normal vector n of the plane mirror in the camera coordinate system. First, from a plurality of known corresponding points pxi and pai of the actual-image area 121 and the mirror-image area 122 in the image, a direct light vector xi and an incident light vector ai corresponding thereto are calculated on the basis of a lens strain coefficient of the camera. Since the incident light vector ai, the direct light vector xi, and the normal vector n are on the same plane, the following relational expression is satisfied:

x·(n×a)=0

where “·” represents the inner product and “×” represents the outer product.

A normal vector n can be found from the reflected vector b, instead of the incident light vector a. The reflected light vector b is given by the following relational expression:

b=a−2(a·n)n

Simultaneous equations defined by the above relational expressions can be solved for n by using, for example, eigenvalue decomposition (svd) serving as one method of matrix decomposition for a matrix. In the method of the embodiment, the normal vector n can be calculated by obtaining three pairs of corresponding points.

Next, the angle θ is calculated. The angle θ refers to an angle (scalar) formed between the normal vector n and the unit vector (i=(0, 1, 0)) in the Y-axis direction of the camera coordinate system. The angle θ is scalar, and can be calculated according to the cosine theorem. When the angle θ is obtained, a three-dimensional rotation matrix is calculated for rotation by θ on a vector determined by the outer product of the normal vector n and the unit vector i in the Y-axis direction (a vector perpendicular to a plane formed by the normal vector n and the unit vector i in the Y-axis direction). The rotation matrix can be found by the Rodrigues' rotation formula for obtaining a rotation matrix for rotation by the angle θ on a certain axis.

In the method of the embodiment, the distance to the object is calculated using the vector and the angle. In calculation using the vector, the normal vector n of the mirror is a factor needed beforehand. The normal vector n of the mirror can be found by tripartite observation. Therefore, calibration is easier than in the known method based on the coordinates. The angle θ formed between the normal vector n and the Y-axis of the camera coordinate system can be calculated from standard algebraic and geometric knowledge.

Calculation of Distance to Object

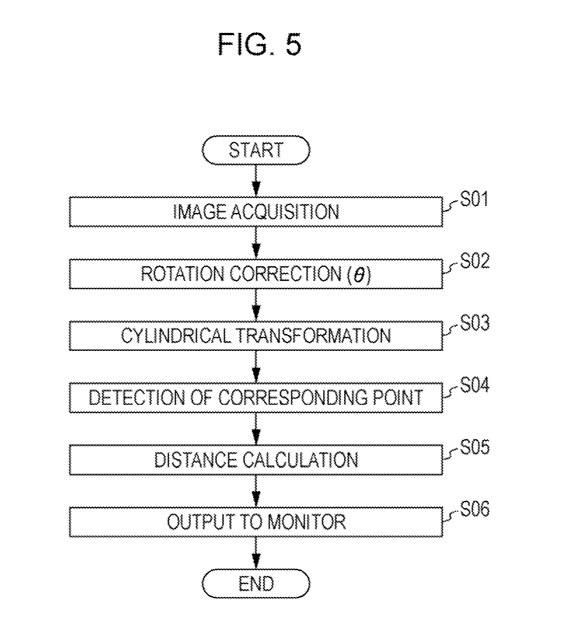

Next, a description will be given of calculation of the distance for an image captured as needed. FIG. 5 is a flowchart illustrating a process for calculation of the distance.

The ECU 30 functions as the distance calculation module 35. The ECU 30 receives an image input from the camera device 10 (S01), corrects the angle (S02), performs cylindrical transformation (S03), detects correcting points (S04), calculates distances to an object (S05), and combines calculation results and outputs the results as an output image to the monitor (S06). These steps will be described in order below.

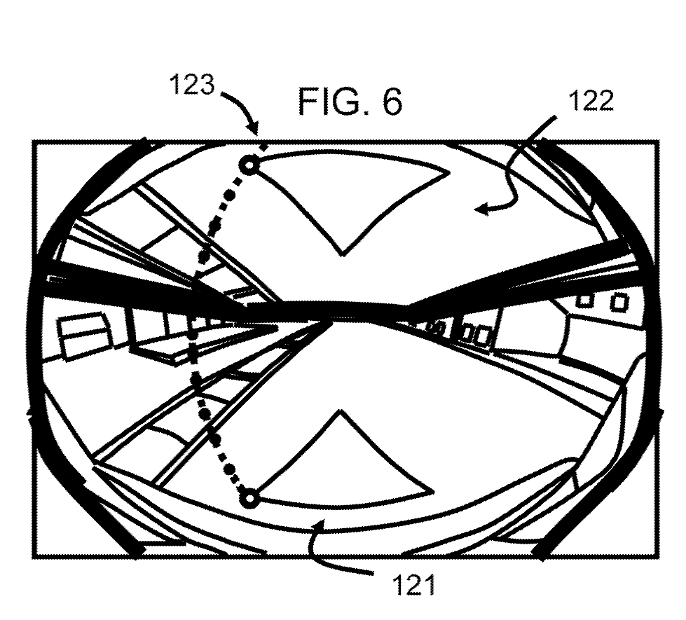

The ECU 30 receives an original image obtained by the image pickup element 12 (S01). In the embodiment, the original image is a fisheye image, as illustrated in FIG. 6. The original image includes a real-image area 121 and a mirror-image area 122. In FIG. 6, an area surrounded by a white broken line serves as the mirror-image area 122, and an area other than the mirror-image area 122 serves as the real-image area 121. A broken line 123 connects pixels that have the same orientation in the X-axis direction of the camera coordinate system. The broken line for separating the real-image area 121 and the mirror-image area 122 and the broken line 123 are added for explanation, but are not seen in the actual original image.

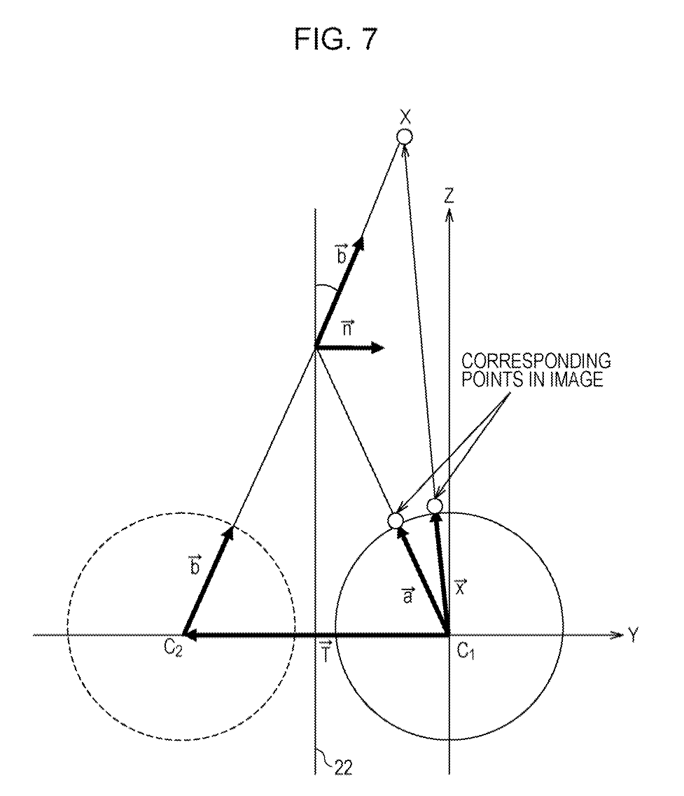

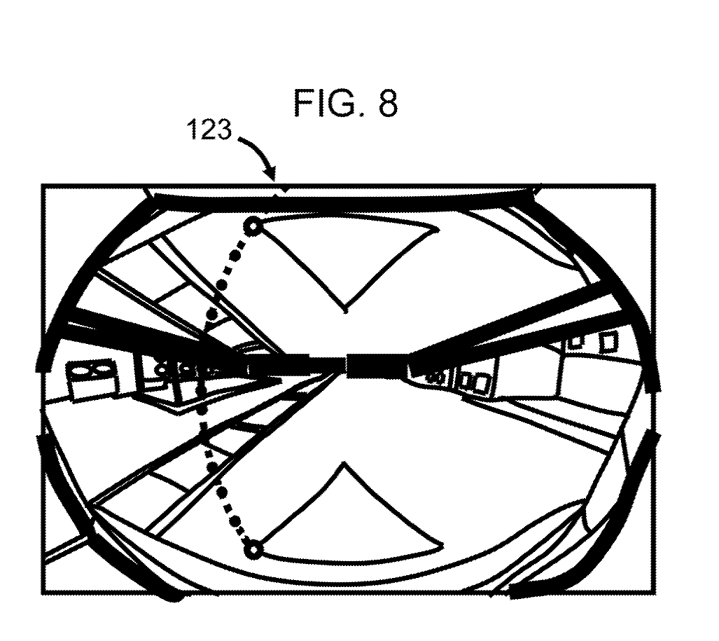

Next, the ECU 30 rotates the original image by the angle (−θ) in the camera coordinate system on the basis of the angle θ calculated beforehand (S02). After this rotation correction, the Y-axis of the camera coordinate system is made parallel to the normal vector n, as illustrated in FIG. 7. Further, the base line vector T and the Y-axis of the camera coordinate system coincides with each other. Hence, the normal vector n is parallel to the unit vector of the Y-axis. FIG. 8 illustrates a fisheye image obtained by rotation correction for making the normal vector n and the Y-axis of the camera coordinate system parallel.

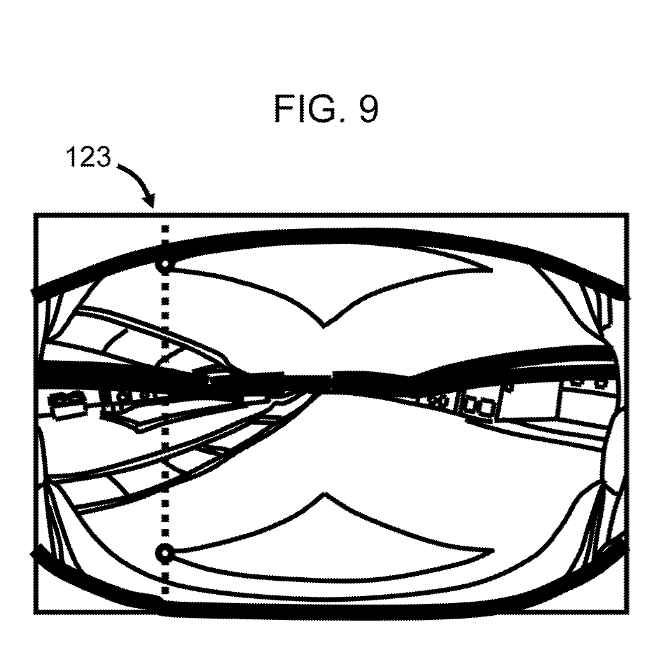

Next, the ECU 30 conducts cylindrical transformation on the fisheye image subjected to rotation correction in S02 (S03). A fisheye image captured by the fisheye lens is an image obtained by projecting an image, which is seen on a hemispherical surface, onto a planar surface. Hence, even when an actual line is straight in the vertical direction, it is curved in the vertical direction in the fisheye image captured by the fisheye lens, except a vertical straight line passing through the horizontal center of the image. In the embodiment, cylindrical transformation refers to correction made so that the vertical line in the fisheye image becomes straight in the vertical direction like the actual vertical line. Cylindrical transformation allows the vertical line in the fisheye image to be reproduced as a vertical straight line. Hereinafter, an image subjected to cylindrical transformation is referred to as a cylindrical image. By cylindrical transformation, a corresponding point in the mirror-image area and a corresponding point in the real-image area exist on the same x-coordinate (corresponding to the azimuth) in the cylindrical image. As a result, the ECU 30 can more efficiently search for the corresponding points. Alternatively, the corresponding points can be directly found from the fisheye image subjected to cylindrical transformation. Since the operation of searching for the corresponding points is performed after cylindrical transformation, the operation is facilitated. FIG. 9 illustrates a cylindrical image obtained by conducting cylindrical transformation on the fisheye image subjected to rotation correction. As a result of cylindrical transformation, the line 123 has the same x-coordinate.

Next, the ECU 30 searches for corresponding points in the real image and the mirror image for each pixel in the cylindrical image (S04). For example, the ECU 30 searches for corresponding points to which block matching using the sum of absolute differences or normalized correlation is applied.

Next, the ECU 30 calculates the distance from the camera device 10 to the corresponding points (S05). The coordinates in the cylindrical image correspond to the azimuth angle and elevation angle of light traveling from the center of the camera through the pixel. Therefore, the ECU 30 can properly convert the pixel coordinate values into the azimuth angle and elevation angle.

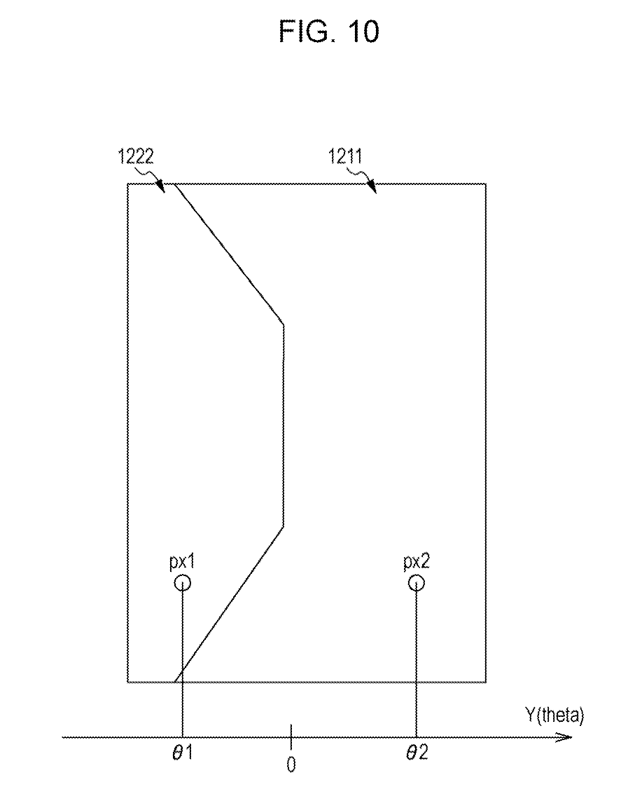

FIG. 10 explains the vertical relationship of a cylindrical image. In FIG. 10, Y represents the Y-axis in the cylindrical image, px1 represents a corresponding point x seen in a mirror-image area 1222 of the cylindrical image, and px2 represents a corresponding point x seen in a real-image area 1211 of the cylindrical image. Further, “0” on the Y-axis represents the position at an elevation angle of 0 degree from the optical axis of the camera (horizontal), θ1 represents the elevation angle from the optical axis of the camera corresponding to the Y-coordinate value of the pixel px1, and θ2 represents the elevation angle from the optical axis of the camera corresponding to the Y-coordinate value of the pixel px2.

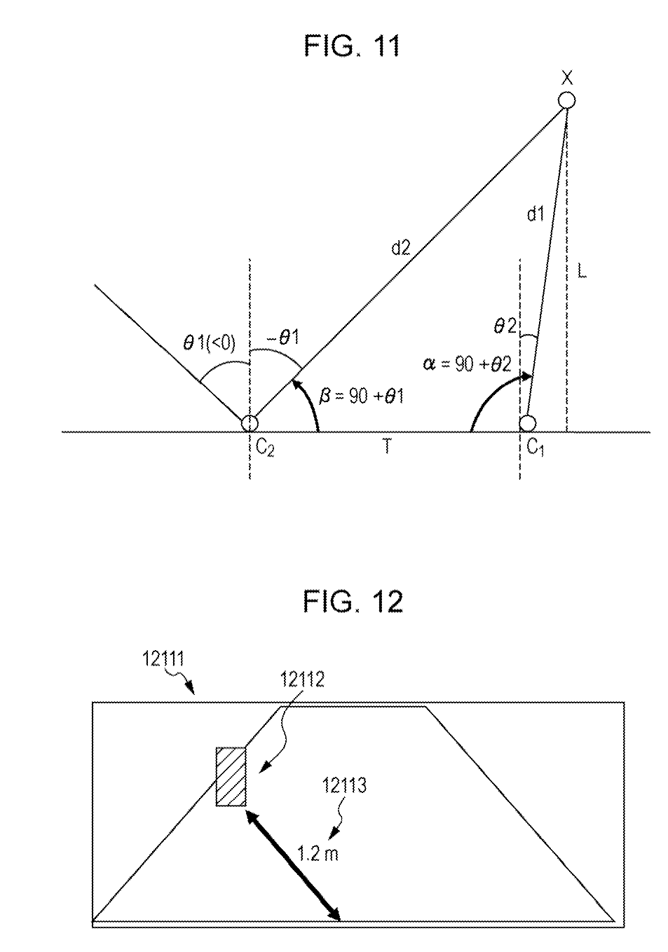

FIG. 11 explains a method for calculating the distance. In FIG. 11, x represents a point to be measured for distance. In FIG. 11, the same reference symbols as those in FIG. 10 denote the same elements. Further, d1 represents the distance from the camera C1 to the point x, d2 represents the distance from the virtual cameral C2 to the point x, α represents the interior angle at the point C1 in a triangle having apexes formed by the points x, C1, and C2, and β represents the interior angle at the point C2 in the triangle. The ECU 30 calculates the distance from the center of the camera C1 to the object point x according to the principle of triangulation, more specifically, according to Relational Expression (1). In Relational Expression (1), T is a scale factor. A conversion value of the distance between the camera C1 and the virtual camera C2 is found beforehand by, for example, calibration.

$${d}_{2} = T \frac{sin β}{sin ( α + β )} = T \frac{sin ( 90 + {θ}_{1} )}{sin ( 180 + {θ}_{1} + {θ}_{2} )} = T \frac{- cos {θ}_{1}}{sin ( {θ}_{1} + {θ}_{2} )} \qquad ( 1 )$$

Through the above-described process, the ECU 30 calculates the distance from the camera to the object.

Detection of Obstacle

A description will now be given of an obstacle detecting operation of the ECU 30. The ECU 30 functions as the obstacle detection module 36, and detects an obstacle by an obstacle sensing module that adopts information about the distance by the distance calculating operation and existing distance information. For example, the distance calculating operation is an image-recognition technique. For example, the ECU 30 deletes corresponding points on the road surface plane from the distance information on the basis of the mounting height and elevation angle of the camera device 10 and the road surface plane that are acquired beforehand. Then, the ECU 30 detects the remaining corresponding points as an obstacle.

Display on Image

Next, a description will be given of an image composition operation of the ECU 30. Here, a cylindrical image or a fisheye image subjected to rotation correction may be used. The ECU 30 functions as the image generating module 37, and generates notice information on the basis of information about the detected obstacle. For example, the notice information is numerical information about the distance to the obstacle, and gives a warning that the distance to the obstacle is shorter than a predetermined distance. The ECU 30 extracts an area to be displayed on the monitor 40 from the real-image area 1211 of the cylindrical image. Then, the ECU 30 superimposes the generated notice information on the extracted area so as to generate a monitor display image, and outputs the generated monitor display image to the monitor 40 (S06). FIG. 12 illustrates an example of an image to be output to the monitor 40. In FIG. 12, reference numeral 12111 denotes a real-image area, reference numeral 12112 denotes an area detected as an obstacle in the image, and reference numeral 12113 denotes an arrow to the obstacle and the distance to the obstacle.

From the above, the distance estimating apparatus 5 can monitor the surroundings of the vehicle with one camera device and one mirror at a wide angle of view in the lateral direction, detect an obstacle around the vehicle, calculate the distance to the obstacle, and display the distance on the monitor. Moreover, since only one mirror is used, calibration is easier than in the method for using a plurality of mirrors in combination.

Alternatively, the mirror 20 may be formed by a curved mirror, instead of the plane mirror. However, in the case of the curved mirror, the normal vector of the mirror differs according to the position on the mirror. It is therefore necessary to calculate the normal vector of the curved mirror beforehand in accordance with the position in the image pickup element. In distance measurement, the normal vector is determined by the coordinates of the image pickup area so as to calculate the distance to the object.

In the present invention, one mirror is used. Therefore, a rearview auxiliary mirror or a side mirror existing in the vehicle 1 can also be used. When the rearview auxiliary mirror or the side mirror is used, the cost can be reduced further. In this case, for example, the angle of the mirror during distance measurement is determined beforehand, and is stored in the memory 32 or the like. In normal driving, the driver arbitrarily determines the angle of the mirror. In distance measurement, the ECU 30 can adjust the angle of the mirror for the camera device, for example, by turning the mirror to the predetermined angle.

The above-described distance estimating apparatus 5 has a great ability to monitor the surroundings of the vehicle 1. That is, the distance estimating apparatus 5 can capture an image at a wide angle in the horizontal direction, and allows distance measurement by using the unnecessary area in the vertical direction as the area for a mirror image. Hence, an easy view of the surroundings is achieved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiment of the present inventions have been described in detail, it should be understood that the various changes, substitutions, and alterations could be made hereto without departing from the spirit and scope of the invention.

What is claimed is:

1. A distance estimating apparatus for estimating a distance to an object, comprising:
a mirror;
a camera device for obtaining an original image including a real image of the object and a mirror image of the object mirrored by the mirror; and
a processor for calculating a distance between the camera device and the object on the basis of a correlation of a position of the real image included in the original image and a position of the mirror image included in the original image.

2. The distance estimating apparatus according to claim 1, wherein the camera device is set with a depression angle such that a lower end of the real-image area can capture the image of a road surface.

3. The distance estimating apparatus according to claim 2, wherein the camera device is set below the rear end of a vehicle.

4. The distance estimating apparatus according to claim 1, wherein the camera device has fisheye lens.

5. The distance estimating apparatus according to claim 1, wherein the mirror is set on the upper side of the camera device in a manner to face the road surface.

6. The distance estimating apparatus according to claim 1, wherein the mirror is set so that an upper half of the original image of the camera device serves as the mirror image area.

7. The distance estimating apparatus according to claim 1, wherein the processor detects the real image of the object and the mirror image of the object by using an image-recognition technique.

8. The distance estimating apparatus according to claim 1, further comprising a monitor for displaying the distance.

9. The distance estimating apparatus according to claim 1, wherein the process calculates the distance by using a direction of an optical axis of the camera device and a direction of a normal vector of the mirror.
